(19) United States
(12) Patent Application Publication
(10) Pub. No.: US 2026/0332019 A1
(43) Pub. Date: Oct. 22, 2026

(54) TITLE MAGNETIC GEAR AND MAGNETIC-GEARED MOTOR INCLUDING SAME

(71) Applicants: SAMSUNG ELECTRONICS CO., LTD., Suwon-si (KR); Industry-University Cooperation Foundation Hanyang University (UCF-HYU), Seoul (KR)

(72) Inventors: Jaewoong JUNG, Suwon-si (KR); Ukho SEO, Suwon-si (KR); Seunghun LEE, Seoul (KR); Myungseop LIM, Seoul (KR); Soyeon IM, Seoul (KR)

(73) Assignees: SAMSUNG ELECTRONICS CO., LTD., Suwon-si (KR); Industry-University Cooperation Foundation Hanyang University (UCF-HYU), Seoul (KR)

(21) Appl. No.: 19/468,736

(22) Filed: Feb. 3, 2026

Related U.S. Application Data
(63) Continuation of application No. PCT/KR2024/008740, filed on Jun. 25, 2024.

(30) Foreign Application Priority Data
Aug. 18, 2023 (KR) 10-2023-0108640

(51) Int. Cl. H02K 49/10

(52) U.S. Cl. CPC H02K 49/102

(57) ABSTRACT

A magnetic gear including an inner rotor, an outer rotor, and a pole piece. The pole piece includes a plurality of pole piece bodies arrangeable along a radial direction with to the rotation axis and spaced apart from each other, and a plurality of bridges, arrangeable to protrude from the plurality of pole piece bodies, respectively, configured to connect adjacent pole piece bodies among the plurality of pole piece bodies. The plurality of pole piece bodies respectively comprise a through-hole formed on the plurality of pole piece bodies, respectively, a recessed portion, formed on a bottom surface of the plurality of pole piece bodies, respectively, facing the inner rotor, and fillets, configured to be connected to the plurality of bridges, formed on side surfaces of the plurality of pole piece bodies, respectively, such that the adjacent pole piece bodies among the plurality of pole piece bodies face each other.

### CROSS-REFERENCE TO RELATED APPLICATION

This application is a continuation application, under 35 U.S.C. § 111(a), of international application No. PCT/KR2024/008740, filed Jun. 25, 2024, which claims priority under 35 U. S. C. § 119 to Korean Patent Application No. 10-2023-0108640, filed Aug. 18, 2023, the disclosures of which are incorporated herein by reference in their entireties.

### TECHNICAL FIELD

The disclosure a magnetic gear including pole piece and a magnetic geared motor including the same.

### BACKGROUND ART

A magnetic gear is a gear system that transmits power using magnetic forces. Unlike conventional mechanical gears, magnetic gears may transmit power from an inner rotor to an outer rotor without physical contact. As result, magnetic gears have the advantages of low noise and vibration, and no wear due to interaction between gears. In addition, since there is no mechanical friction, energy loss may be reduced, resulting in high-efficiency driving. In recent years, magnetic gears have been utilized across a wide range of industries, including wind turbines, electric vehicles, and home appliances.

A magnetic gear includes an inner rotor that receives power from a motor or the like, an outer rotor disposed spaced apart from the inner rotor and receiving power from the inner rotor through magnetic force, and pole piece disposed between the inner rotor and the outer rotor and spaced apart from the inner rotor and the outer rotor. The pole piece serves to regulate and transmit a magnetic field between the inner rotor and the outer rotor.

### DISCLOSURE

### Technical Problem

An embodiment of the present disclosure provides a magnetic gear capable of reducing torque ripple, and a magnetic geared motor including the same.

An embodiment of the present disclosure provides a magnetic gear capable of improving power density, and a magnetic geared motor including the same.

Technical tasks to be achieved in this document are not limited to the technical tasks mentioned above, and other technical tasks not mentioned will be clearly understood by those skilled in the art from the description below.

### Technical Solution

A magnetic gear according to an embodiment of the present disclosure includes an inner rotor configured to receive rotational power. The magnetic gear includes an outer rotor to be disposed coaxially with a rotation axis of the inner rotor and spaced apart from the inner rotor. The magnetic gear includes a pole piece to be disposed between the inner rotor and the outer rotor and spaced apart from the inner rotor and the outer rotor. The pole piece includes a plurality of pole piece bodies arrangeable along a radial direction with to the rotation axis and spaced apart from each other while the pole piece is disposed between the inner rotor and the outer rotor. The pole piece includes a plurality of bridges, arrangeable to protrude from the plurality of pole piece bodies, respectively, configured to connect adjacent pole piece bodies among the plurality of pole piece bodies. The plurality of pole piece bodies includes a through-hole formed on the plurality of pole piece bodies, respectively. The plurality of pole piece bodies includes a recessed portion, formed on a bottom surface of the plurality of pole piece bodies, respectively, facing the inner rotor. The plurality of pole piece bodies includes fillets, configured to be connected to the plurality of bridges, formed on side surfaces of the plurality of pole piece bodies, respectively, such that the adjacent pole piece bodies face each other.

A magnetic geared motor according to an embodiment of the present disclosure includes a motor. The magnetic geared motor includes an inner rotor to be connected to a rotation axis and configured to be rotated by the motor. The magnetic geared motor includes an outer rotor configured to accommodate the inner rotor and disposed spaced apart from the inner rotor. The magnetic geared motor includes a pole piece disposed between the inner rotor and the outer rotor and spaced apart from the inner rotor and the outer rotor. The pole piece includes a plurality of pole piece bodies arrangeable along a radial direction with to the rotation axis and spaced apart from each other. The pole piece includes a plurality of bridges, arrangeable to protrude from the plurality of pole piece bodies, respectively, configured to connect adjacent pole piece bodies among the plurality of pole piece bodies. The plurality of pole piece bodies includes a through-hole formed on the plurality of pole piece bodies, respectively. The plurality of pole piece bodies respectively include a recessed portion formed on a first body surface facing the inner rotor in a direction from the inner rotor toward the outer rotor. The plurality of pole piece bodies respectively include fillets formed on a second body surface facing pole piece bodies adjacent to each other and configured to be connected to the plurality of bridges.

A magnetic gear according to an embodiment of the present disclosure includes an inner rotor configured to rotate. The magnetic gear includes an outer rotor disposed spaced apart from the inner rotor and configured to accommodate the inner rotor. The magnetic gear includes a pole piece disposed between the inner rotor and the outer rotor and spaced apart from the inner rotor and the outer rotor. The pole piece includes a plurality of pole piece bodies arrangeable along a radial direction with to the rotation axis. The pole piece includes a plurality of bridges configured to connect adjacent ones of the plurality of pole piece bodies. The plurality of pole piece bodies includes a through-hole, respectively. The plurality of pole piece bodies includes a recessed portion formed on one surface facing the inner rotor. The plurality of pole piece bodies respectively include fillets formed on another surface facing the adjacent pole piece bodies.

### DESCRIPTION OF DRAWINGS

FIG. 1 is a view illustrating a magnetic geared motor according to an embodiment.

FIG. 2 is an exploded view of the magnetic geared motor according to an embodiment.

FIG. 3 is a front view of the magnetic geared motor according to an embodiment.

FIG. 4 is an enlarged view of a portion of the front of the magnetic geared motor according to an embodiment.

FIG. 5 is an enlarged view of a portion of the front of a magnetic geared motor according to an embodiment.

FIG. 6 is an enlarged view of a portion of the front of a magnetic geared motor according to an embodiment.

FIG. 7 is an enlarged view of a portion of the front of a magnetic geared motor according to an embodiment.

FIG. 8 is an enlarged view of a portion of the front of a magnetic geared motor according to an embodiment.

### DETAILED DESCRIPTION OF THE EMBODIMENTS

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

In referring to rotational directions, a clockwise direction may be referred to as a first direction, and a counter-clockwise direction, which is opposite to the first direction, may be referred to as a second direction. While such terminology may be used for convenience in the detailed description for carrying out the disclosure, the rotational directions of the components of the present disclosure are not limited by these terms.

Hereinafter, a magnetic geared motor according to various embodiments will be described in detail with reference to the accompanying drawings.

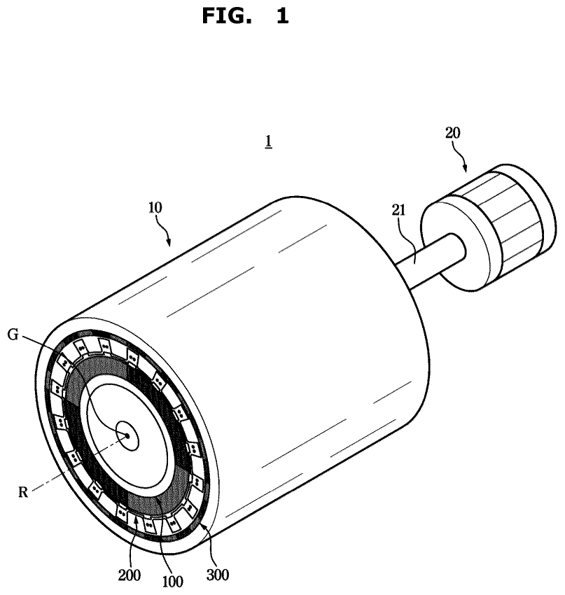

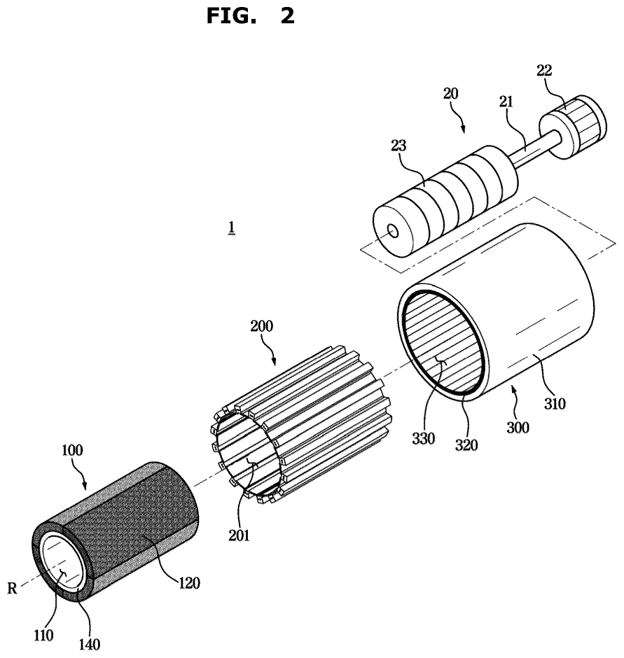

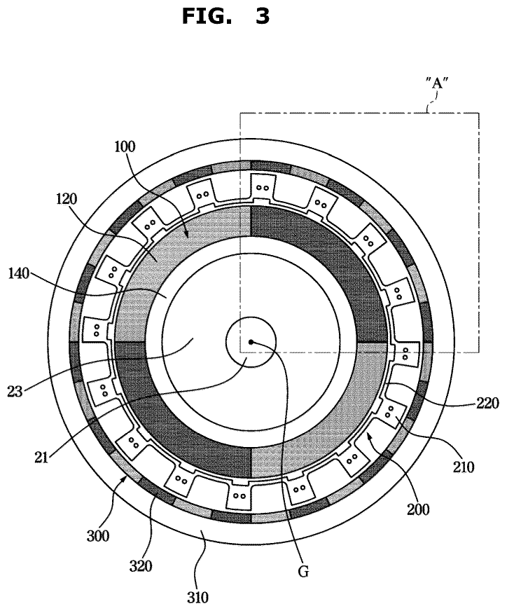

FIG. 1 is a view illustrating a magnetic geared motor according to an embodiment. FIG. 2 is an exploded view of the magnetic geared motor according to an embodiment. FIG. 3 is a front view of the magnetic geared motor according to an embodiment.

Referring to FIGS. 1 to 3, a magnetic geared motor 1 may include a rotating portion 20. The rotating portion 20 may include a motor 22. The rotating portion 20 may include a shaft 21. The rotating portion 20 may include an inner rotor coupling portion 23.

The motor 22 may generate rotational power. One end of the shaft 21 may be coupled to the motor 22. The motor 22 may rotate the shaft 21 by transmitting rotational power to the shaft 21. The shaft 21 may rotate about a rotation axis R by receiving the rotational power from the motor 22.

The shaft 21 may be configured to extend in a first direction. The shaft 21 may have a substantially cylindrical shape.

The inner rotor coupling portion 23 may be coupled to the other end of the shaft 21. When the motor 22 generates rotational power and the shaft 21 coupled to the motor 22 rotates, the inner rotor coupling portion 23 may rotate along with the rotation of the shaft 21. The inner rotor coupling portion 23 may be inserted into an inner rotor opening 110 to transmit rotational power to an inner rotor 100 (described later).

The magnetic geared motor 1 may include a magnetic gear 10.

The magnetic gear 10 may include the inner rotor 100. The inner rotor 100 may include an inner rotor body 140. The inner rotor body 140 may have a substantially cylindrical shape. The inner rotor body 140 may be configured to extend in the first direction. The inner rotor body 140 may include a magnetic material.

The inner rotor body 140 may include the inner rotor opening 110. The inner rotor opening 110 may be formed to extend along the first direction inside the inner rotor body 140. The inner rotor coupling portion 23 of the rotating portion 20 may be inserted into the inner rotor opening 110 to be coupled with the inner rotor 100. By coupling the inner rotor coupling portion 23 to the inner rotor opening 110, the inner rotor 100 may be rotated by receiving the rotational power from the motor 22.

When the inner rotor coupling portion 23 is coupled to the inner rotor body 140, the shaft 21 may be disposed at a rotation center G of the inner rotor 100. In other words, the rotation center G of the inner rotor 100 may be disposed on the rotation axis R. Accordingly, the inner rotor 100 may rotate about the rotation axis R. Thus, the rotation axis R may be the rotation axis R of the inner rotor 100.

The inner rotor coupling portion 23 may be coupled to the inner rotor 100 by a press-fit coupling, but not limited to, with the inner rotor opening 110, and may be coupled to the inner rotor 100 in a variety of ways.

The inner rotor 100 may include inner magnets 120. The inner magnets 120 may be coupled to the inner rotor body 140 along an outer circumferential surface of the inner rotor body 140. In other words, the inner magnets 120 may be arranged radially on the outer circumferential surface of the inner rotor body 140 about the rotation axis R. The inner magnets 120 may be arranged such that magnets with an N-pole on the outer circumferential surface side of the inner rotor body 140 and magnets with an S-pole on the outer circumferential surface side of the inner rotor body 140 are arranged at substantially equal intervals along a circumferential direction of the inner rotor body 140. One N-pole magnet and one S-pole magnet may form a pair of dipoles.

The inner magnets 120 may be arranged to cover the outer circumferential surface of the inner rotor body 140. The inner magnets 120 may be formed to extend along the first direction.

The magnetic gear 10 may include an outer rotor 300. The outer rotor 300 may include an outer rotor body 310. The outer rotor body 310 may have a substantially cylindrical shape. The outer rotor body 310 may be configured to extend in the first direction. The outer rotor body 310 may include a magnetic material.

The outer rotor body 310 may include an outer rotor opening 330. The outer rotor opening 330 may be formed to extend along the first direction inside the outer rotor body 310. The inner rotor 100 may be inserted into the outer rotor opening 330. The inner rotor 100 may be inserted into the outer rotor opening 330 such that it is spaced apart from the outer rotor 300. A center of the outer rotor 300 may be disposed on the rotation axis R of the inner rotor 100.

The outer rotor 300 may include outer magnets 320. The outer magnets 320 may be coupled to the outer rotor body 310 along an inner circumferential surface of the outer rotor body 310. In other words, the outer magnets 320 may be arranged radially on the inner circumferential surface of the outer rotor body 310 about the rotation axis R. The outer magnets 320 may be arranged such that magnets with an N-pole on the inner circumferential surface side of the outer rotor body 310 and magnets with an S-pole on the inner circumferential surface side of the outer rotor body 310 are arranged at substantially equal intervals along the inner circumferential surface of the outer rotor body 310. One N-pole magnet and one S-pole magnet may form a pair of dipoles.

The outer magnets 320 may be arranged to cover the inner circumferential surface of the outer rotor body 310. The outer magnets 320 may be formed to extend along the first direction.

The magnetic gear 10 may include a pole piece 200.

The pole piece 200 may include a plurality of pole piece bodies 210. Each of the plurality of pole piece bodies 210 may be configured to extend in the first direction. The plurality of pole piece bodies 210 may be arranged radially. The plurality of pole piece bodies 210 may be spaced apart from each other at substantially equal intervals and arranged radially. The pole piece 200 may include a magnetic material.

The pole piece 200 may include a plurality of bridges 220. Each of the plurality of bridges 220 may be configured to connect adjacent pole piece bodies 210 of the plurality of pole piece bodies 210. The plurality of bridges 220 may each be configured to protrude from the pole piece bodies 210.

The plurality of bridges 220 may be configured to protrude in a direction toward adjacent pole piece 200. Each of the plurality of bridges 220 may be configured to extend in the first direction. The plurality of pole piece bodies 210 may be connected to each other by the plurality of bridges 220, so that the pole piece 200 may form a substantially cylindrical shape. Since the plurality of bridges 220 connect the plurality of pole piece bodies 210 to each other, the pole piece bodies 210 may be supported by each other and have greater support strength, which may improve power transmission and gear ratio accuracy.

The pole piece bodies 210 and the plurality of bridges 220 may be integrally formed.

The pole piece 200 may include a pole piece opening 201. The pole piece opening 201 may extend along the pole piece 200 in the first direction and be formed inside the pole piece 200.

The outer rotor 300 and the inner rotor 100 may be disposed to be spaced apart from each other, and an inner space S1 may be formed between the outer rotor 300 and the inner rotor 100. The pole piece 200 may be disposed to be inserted into the inner space S1. When the pole piece 200 is inserted into the inner space S1, the inner rotor 100 may be in a state of being inserted into the pole piece opening 201.

The pole piece 200 may be disposed between the inner rotor 100 and the outer rotor 300 such that the outer rotor 300 is spaced apart from the inner rotor 100. Thus, the inner rotor 100, the pole piece 200, and the outer rotor 300 may be disposed such that they do not to contact each other.

The inner rotor 100 may rotate in a first rotation direction with respect to the rotation center G by receiving rotational power from the motor 22. When the inner rotor 100 rotates in the first rotation direction, the pole piece 200 is stationary, and the pole piece 200 may magnetically couple the inner magnets 120 of the inner rotor 100 and the outer magnets 320 of the outer rotor 300.

The number of pole piece bodies 210 may be calculated as follows, with the number of dipoles of the inner rotor 100 and the number of dipoles of the outer rotor 300 as variables.

Ns=p1−p2 [Equation 1]

As the pole piece 200 magnetically couple the inner magnets 120 and the outer magnets 320, the pole piece 200 may generate spatial harmonics to magnetically transfer power from the inner rotor 100 to the outer rotor 300 with a constant gear ratio.

The gear ratio may have the number of dipoles of the inner rotor 100 and the number of dipoles of the outer rotor 300 as variables. It may be calculated as follows, using the rotational speed of the inner rotor 100 and the rotational speed of the outer rotor 300 as variables.

Gr=p2/p1=−(w1/w2) [Equation 2]

In conclusion, the outer rotor 300 may receive power magnetically to rotate. When the inner rotor 100 rotates in the first rotation direction, the outer rotor 300 may receive power magnetically to rotate in a second rotation direction, which is opposite to the first rotation direction, with respect to the rotation center G.

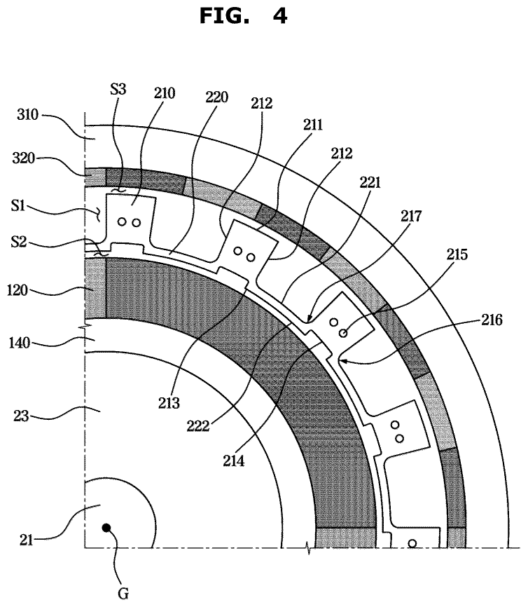

FIG. 4 is an enlarged view of a portion of the front of the magnetic geared motor according to an embodiment.

Referring to FIG. 4, the plurality of pole piece bodies 210 may include a bottom surface 213. The bottom surface 213 may be one surface of the pole piece body 210 facing the inner rotor 100. The bottom surface 213 may refer to one surface of the pole piece body 210 that is most adjacent to the inner rotor 100. The bottom surface 213 may be defined as a first body surface 213 formed on the pole piece body 210.

The plurality of pole piece bodies 210 may include a side surface 212. The side surface 212 may refer to another surface of the pole piece body 210 facing adjacent pole piece bodies 210. The side surfaces 212 may be formed to extend from the bottom surface 213 toward the outer rotor 300 to form another surfaces of the pole piece body 210. The side surfaces 212 may be defined as a second body surface 212 formed on the pole piece body 210.

The plurality of pole piece bodies 210 may include a top surface 211. The top surface 211 may be further another surface of the pole piece body 210 facing the outer rotor 300. The top surface 211 may refer to the further another surface of the pole piece body 210 that is most adjacent to the outer rotor 300. The top surface 211 may extend from a portion of the side surface 212 most adjacent to the outer rotor 300 to form further another surface of the pole piece body 210. The top surface 211 may be defined as a third body surface 211 formed on the pole piece body 210.

Each of the plurality of pole piece bodies 210 may include a through-hole 215 formed therein.

The through-hole 215 may be formed in the pole piece body 210 in a direction parallel to the rotation axis R. The through-hole 215 may be formed to extend along the first direction in which the pole piece body 210 extends, and may penetrate the pole piece body 210.

The through-hole 215 may be provided in a plurality. The plurality of through-holes 215 may include a first through-hole 215a formed on one side of the pole piece body 210. The plurality of through-holes 215 may include a second through-hole 215b formed on the opposite side of the first through-hole 215a with respect to a recessed portion 214. In other words, the through-holes 215 may be formed symmetrically to each other in the pole piece body 210 with respect to the recessed portion 214. While the number of through-holes 215 formed in each pole piece body 210 is shown as two, the number of through-holes 215 formed in each pole piece body 210 is not limited thereto.

The through-holes 215 may be arranged such that the relative permeability at the through-holes 215 is 1.1 or less. More specifically, the pole piece 200 may serve to magnetically couple the inner rotor 100 and the outer rotor 300, and the through-hole 215 may be arranged to have a relative permeability of 1.1 or less to regulate the passage of magnetic flux in the pole piece 200.

As the through-holes 215 are formed in the pole piece body 210, the harmonics in the void magnetic flux density that do not contribute to the torque transmission from the inner rotor 100 to the outer rotor 300 may be improved. This may improve the torque ripple caused by the transmission of power to the outer rotor 300 in the magnetic gear 10.

The pole piece body 210 may include the recessed portion 214.

The recessed portion 214 may be formed on the bottom surface 213 of the pole piece body 210 facing the inner rotor 100. The recessed portion 214 may be formed in a central portion of the bottom surface 213 of the pole piece body 210. The recessed portion 214 may be formed to be recessed in a direction from the inner rotor 100 toward the outer rotor 300.

The recessed portion 214 may be formed in the pole piece body 210 to extend in the first direction. The shape in which the recessed portion 214 is recessed and extends may be a substantially rectangular prism shape, but is not limited thereto.

By forming the recessed portion 214 on the bottom surface 213 of the pole piece body 210, the harmonics in the void magnetic flux density that do not contribute to the torque transmission from the inner rotor 100 to the outer rotor 300 may be improved. This may improve the torque ripple caused by the transmission of power to the outer rotor 300 in the magnetic gear 10.

The pole piece 200 may include a plurality of bridges 220. The plurality of bridges 220 may be formed to protrude from the side surfaces 212 of the pole piece body 210. The plurality of bridges 220 may include a first bridge surface 222 facing the inner rotor 100. The plurality of bridges 220 may include a second bridge surface 221 facing the outer rotor 300.

The pole piece body 210 may include fillets 216 and 217. The fillets 216 and 217 may be formed on the side surfaces 212 of the pole piece body 210 facing adjacent pole piece bodies 210. In other words, the fillets 216 and 217 may be formed on the side surfaces 212 of the pole piece body 210 and provided in a plurality. The plurality of fillets 216 and 217 may be connected to the plurality of bridges 220.

In other words, the plurality of fillets 216 and 217 may be formed on the side where the pole piece body 210 and the plurality of bridges 220 are coupled, and may be formed to extend from the side surfaces 212 of the pole piece body 210 to one surface 221 of the plurality of bridges 220 facing the outer rotor 300.

The fillet 216 may be formed in a concave shape toward the outer rotor 300 on the side where the side surface 212 of the pole piece body 210 and the plurality of bridges 220 are coupled. The one surface 221 of the plurality of bridges 220 may refer to the second bridge surface 221. The plurality of fillets 216 may include a magnetic material, such as the plurality of pole piece bodies 210.

The plurality of fillets 216 and 217 may be added to the connections of the plurality of pole piece bodies 210 and the plurality of bridges 220, a space where the plurality of fillets 216 and 217 are formed may be filled with a magnetic material. In the absence of the plurality of fillets 216 and 217, the space would be filled with air or the like, but because the space may be filled with a magnetic material having a higher relative permeability than air, more magnetic flux may flow through the pole piece 200. As the magnetic flux flowing through the pole piece 200 increases, the transmission torque transmitted to the outer rotor 300 by the rotation of the inner rotor 100 may be increased.

As described above, the through-hole 215, the recessed portion 214, and the fillets 216 and 217 may be formed in the pole piece 200. As a result, the loss of eddy currents generated in the inner rotor body 140 and the outer rotor body 310 and the loss of eddy currents generated in the inner magnets 120 and the outer magnets 320 may be reduced.

The first bridge surface 222 of the plurality of bridges 220 may be configured not to form a step with the bottom surface 213 of the pole piece body 210. In other words, the plurality of bridges 220 may protrude from a portion of the side surface 212 of the pole piece body 210 adjacent to the inner rotor 100, and may be formed such that the first bridge surface 222 of the plurality of bridges 220 extends from the bottom surface 213 of the pole piece body 210.

The second bridge surface 221 of the plurality of bridges 220 may be formed to be bent with respect to the side surfaces 212 of the pole piece body 210. The fillets 216 and 217 may be located at the bent portion.

The magnetic gear 10 may include the inner space S1. The inner space S1 may be a cavity created by the separation of the inner rotor 100 and the outer rotor 300. More specifically, the inner space S1 may be a space formed surrounded by the inner magnets 120 of the inner rotor 100 and the outer rotor body 310 of the outer rotor 300.

The inner space S1 may include a pole piece lower space S2. The pole piece lower space S2 may refer to a space between the pole piece 200 and the inner rotor 100. More specifically, the pole piece lower space S2 may refer to the space formed by the separation of the first bridge surface 222 of the bridge 220 and the inner magnets 120 of the inner rotor 100. Furthermore, the pole piece lower space S2 may refer to the space formed by the separation of the bottom surface 213 of the pole piece body 210 and the inner magnets 120 of the inner rotor 100.

The pole piece lower space S2 may be formed wider by the recessed portion 214 on the lower side of the pole piece body 210 than on the lower side of the first bridge surface 222.

The inner space S1 may include a pole piece upper space S3. The pole piece upper space S3 may refer to a space between the pole piece 200 and the outer rotor 300. More specifically, the pole piece upper space S3 may refer to the space formed by the separation of the top surface 211 of the pole piece body 210 and the outer magnets 320 of the outer rotor 300.

As described above, the pole piece 200 may be disposed in the inner space S1 and be spaced apart from both the inner rotor 100 and the outer rotor 300.

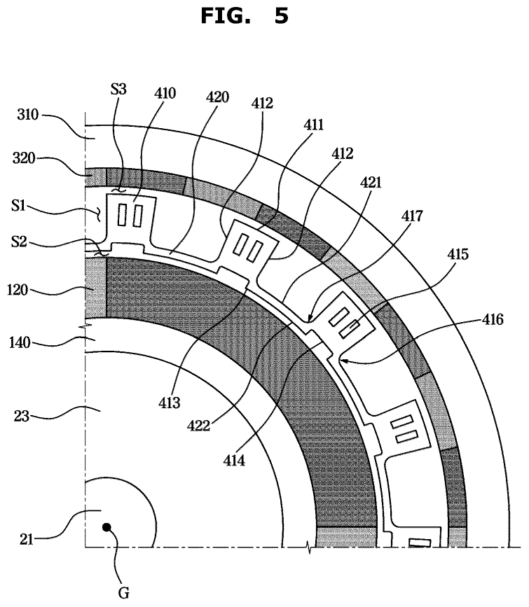

FIG. 5 is an enlarged view of a portion of the front of a magnetic geared motor according to an embodiment. Description herein that is redundant to the above will be omitted.

Referring to FIG. 5, a through-hole 415 may have a slit shape.

The slit may be formed in a pole piece body 410 such that it extends in a direction from the inner rotor 100 toward the outer rotor 300. In other words, a length in the direction from the inner rotor 100 toward the outer rotor 300 may be arranged to be longer than a length in a radial direction formed by a plurality of bridges 420. As shown in FIG. 5, the pole piece body 410 may include a top surface 411, side surfaces 412, bottom surface 413, fillets 416 and 417 and a first bride surface 422 and a second bridge surface 421.

The length of the slit in the direction from the inner rotor 100 toward the outer rotor 300 may be greater than a depth to which a recessed portion 414 is recessed.

The length of the slit in the direction from the inner rotor 100 toward the outer rotor 300 may be greater than a thickness of the plurality of bridges 420.

While two slit-shaped through-holes 415 are shown in the drawing, the number of the through-holes is not limited thereto.

When the through-holes 415 are slit-shaped, the relative permeability at the through-hole may be provided by the slit shape to be 1.1 or less. This may allow the through-hole 415 to be arranged to have a relative permeability of 1.1 or less to regulate the passage of magnetic flux in the pole piece 400. Even when the through-hole 415 is in the form of a slit, the harmonics in the void magnetic flux density that do not contribute to the torque transmission from the inner rotor 100 to the outer rotor 300 may be improved, which may improve the torque ripple caused by the transmission of power to the outer rotor 300 in the magnetic gear 40.

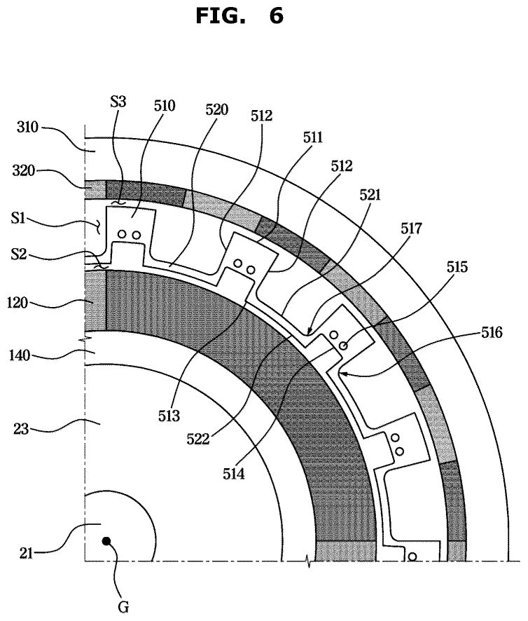

FIG. 6 is an enlarged view of a portion of the front of a magnetic geared motor according to an embodiment. As shown in FIG. 6, the pole piece body 510 may include a top surface 511, side surfaces 512, bottom surface 513, fillets 516 and 517 and a first bride surface 522 and a second bridge surface 521, and a through-hole 515.

Referring to FIG. 6, the depth of a recessed portion 514 may be formed to be greater than the thickness of a plurality of bridges 520.

As the recessed portion 514 is recessed deeper, the degree of improvement of the harmonics of the void magnetic flux density that do not contribute to the torque of the magnetic gear 50 may be adjusted. Depending on the improvement of the harmonics of the void magnetic flux density, the torque ripple may be configured to be reduced.

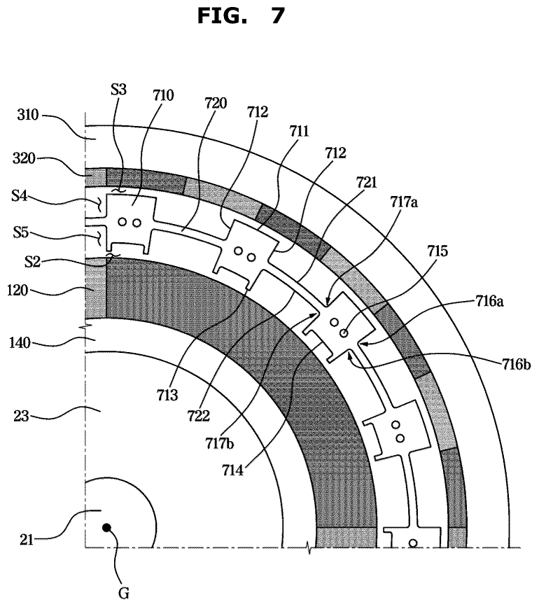

FIG. 7 is an enlarged view of a portion of the front of a magnetic geared motor according to an embodiment.

Referring to FIG. 7, a plurality of bridges 720 may be formed to protrude from a position between a bottom surface 713 and a top surface 711 of side surfaces 712 of a pole piece body 710. The plurality of bridges 720 may be formed to protrude from a central portion of the side surfaces 712 of the pole piece body 710. As shown in FIG. 7, the pole piece body 710 may include a recessed portion 714 and a through-hole 715.

The plurality of bridges 720 may include a first bridge surface 722 facing the inner rotor 100 and a second bridge surface 721 facing the outer rotor 300. Since the plurality of bridges 720 protrude from the side surfaces 712 between the bottom surface 713 and the top surface 711, the portions where the plurality of bridges 720 and the side surface 712 of the pole piece body 710 are bent may be formed at a lower and upper portions with respect to the plurality of bridges 720.

Fillets 716 and 717 may include first fillets 716b and 717b extending to the first bridge surface 722. The first fillets 716b and 717b may be formed at the lower portion with respect to the plurality of bridges 720 and may extend with the side surface 712. The first fillets 716b and 717b may be formed to extend from the side surface 712 to the first bridge surface 722. The first fillets 716b, and 717b may have a concave shape in the direction facing the inner rotor 100.

The fillets 716 and 717 may include second fillets 716a and 717a extending to the second bridge surface 721. The second fillets 716a and 717a may be formed at the upper portion with respect to the plurality of bridges 720 and may extend with the side surface 712. The second fillets 716a and 717a may be formed to extend from the side surface 712 to the second bridge surface 721. The second fillets 716a and 717a may have a concave shape in the direction facing the outer rotor 300.

The first fillets 716b and 717b and the second fillets 716a and 717a may have shapes that are symmetrical to each other with respect to the plurality of bridges 720.

Because the fillets 716 and 717 are formed on both the upper and lower portions with respect to the plurality of bridges 720, the space where the plurality of fillets 716, 717 are formed may be filled with a magnetic material. In the absence of the plurality of fillets 716 and 717, the space would be filled with air or the like, but because the space is filled with a magnetic material having a higher relative permeability than air, more magnetic flux may flow through the pole piece 700. As the magnetic flux flowing through the pole piece 700 increases, the transmission torque transmitted to the outer rotor 300 by the rotation of the inner rotor 100 may be increased.

The inner space S1 may include a first inner space S4. The first inner space S4 may refer to a space formed between the second bridge surface 721 and the outer magnets 320. The first inner space S4 may be larger than the pole piece upper space.

The inner space S1 may include a second inner space S5. The second inner space S5 may refer to a space formed between the first bridge surface 722 and the inner magnets 120. The first inner space S4 may be c larger than the pole piece upper space.

The first inner space S4 and the second inner space S5 may have corresponding sizes.

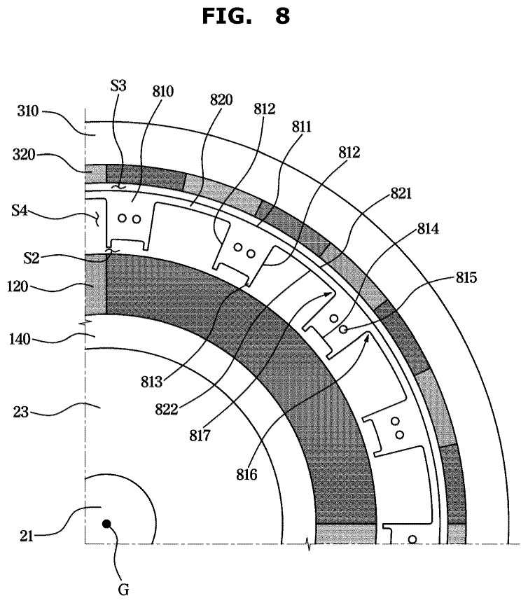

FIG. 8 is an enlarged view of a portion of the front of a magnetic geared motor according to an embodiment.

Referring to FIG. 8, one surface 821 of a plurality of bridges 820 may be arranged not to form a step with a top surface 811 of a pole piece body 810. In other words, the plurality of bridges 820 may protrude from a portion of a side surface 812 of the pole piece body 810 adjacent to the outer rotor 300, and may be formed such that the one surface 821 of the plurality of bridges 820 extends from the top surface 811 of the pole piece body 810. The one surface 821 may refer to a second bridge surface 821. Thus, a recessed portion 814 may be formed closer to the inner rotor 100 than the one surface 821. As shown in FIG. 6, the pole piece body 510 may a bottom surface 813 and a through-hole 815.

A first bridge surface 822 of the plurality of bridges 820 may be formed to be bent with respect to the side surfaces 812 of the pole piece body 810. Fillets 816 and 817 may be located at the bent portion.

The magnetic gear 10 according to an embodiment may include the inner rotor 100 configured to receive rotational power. The magnetic gear 10 may include the outer rotor 300 disposed coaxially with the rotation axis R of the inner rotor 100 and spaced apart from the inner rotor 100. The magnetic gear 10 may include the pole piece 200 disposed between the inner rotor 100 and the outer rotor 300 and spaced apart from the inner rotor 100 and the outer rotor 300. The pole piece 200 may include the plurality of pole piece bodies 210 arranged radially. The pole piece 200 may include the plurality of bridges 220 protruding from each of the plurality of pole piece bodies 210 and configured to connect adjacent ones of the plurality of pole piece bodies 210. Each of the plurality of pole piece bodies 210 may include the through-hole 215 formed therein. Each of the plurality of pole piece bodies 210 may include the recessed portion 214 formed on the bottom surface 213 facing the inner rotor 100. Each of the plurality of pole piece bodies 210 may include the fillets 216 and 217 formed on side surfaces 212 facing pole piece bodies 210 adjacent to each other and configured to be connected to the plurality of bridges 220.

The recessed portion 214 may be recessed in a direction from the inner rotor 100 toward the outer rotor 300.

Each of the plurality of bridges 220 may be formed to protrude from the side surfaces 212.

Each of the plurality of bridges 220 may include the first bridge surface 222 facing the inner rotor 100, the first bridge surface 222 being configured not to form a step with the bottom surface 213.

The through-hole 215 may be formed in the pole piece body 210 in a direction parallel to the rotation axis R.

The through-hole 215 may include the first through-hole 215a formed on one side of the pole piece body 210 and the second through-hole 215b formed on the opposite side of the first through-hole 215a with respect to the recessed portion 214.

The through-hole 415 may have a slit shape.

The through-hole 215 may be provided to have the relative permeability of 1.1 or less.

A depth of the recessed portion 514 may be formed to be greater than the thickness of each of the plurality of bridges 520.

Each of the plurality of bridges 220 may further include the second bridge surface 221 facing the outer rotor 300. The fillets 216 and 217 may be formed to extend from the side surfaces 212 to the second bridge surface 221.

The pole piece body 710 may further include the top surface 711 facing the outer rotor 300, and the plurality of bridges 720 may be formed to protrude between the bottom surface 713 and the top surface 711.

Each of the plurality of bridges 720 may include the first bridge surface 722 facing the inner rotor 100 and the second bridge surface 721 facing the outer rotor 300. The fillets 716 and 717 may include the first fillets 716b and 717b formed to extend from the side surfaces 712 to the first bridge surface 722 and the second fillets 716a and 717a formed to extend from the side surfaces 712 to the second bridge surface 721.

Each of the plurality of bridges 820 may include the bridge surface 821 facing the outer rotor 300. The pole piece body 810 may include the top surface 811 facing the outer rotor 300. The bridge one surface 820 may be arranged not to form a step with the top surface 811.

The recessed portion 814 may be formed closer to the inner rotor 100 than the bridge surface.

The magnetic geared motor 1 according to an embodiment may include the motor 22. The magnetic geared motor 1 may include the inner rotor 100 connected to the rotation axis R and configured to be rotated by the motor 22. The magnetic geared motor 1 may include the outer rotor 300 configured to accommodate the inner rotor 100 and disposed spaced apart from the inner rotor 100. The magnetic geared motor 1 may include the pole piece 200 disposed between the inner rotor 100 and the outer rotor 300 and spaced apart from the inner rotor 100 and the outer rotor 300. The pole piece 200 may include the plurality of pole piece bodies 210 arranged radially. The pole piece 200 may include the plurality of bridges 220 protruding from each of the plurality of pole piece bodies 210 and connecting adjacent ones of the plurality of pole piece bodies 210. Each of the plurality of pole piece bodies 210 may include the through-hole 215 formed therein. Each of the plurality of pole piece bodies 210 may include the recessed portion 214 formed on the first body surface 213 facing the inner rotor 100 in a direction from the inner rotor 100 toward the outer rotor 300. Each of the plurality of pole piece bodies 210 may include the fillets 216 and 217 formed on the second body surface 212 facing pole piece bodies 210 adjacent to each other and configured to be connected to the plurality of bridges 220.

Each of the plurality of bridges 220 may be formed to protrude from the second body surface 212.

Each of the plurality of bridges 220 may include the first bridge surface 222 facing the inner rotor 100, the first bridge surface 222 being configured not to form a step with the first body surface 213.

The pole piece body 710 may further include the third body surface 711 facing the outer rotor 300, and the plurality of bridges 720 may be formed to protrude between the first body surface 713 and the third body surface 711.

Each of the plurality of bridges 820 may include a bridge surface facing the outer rotor 300. The pole piece body 810 may include the top surface 811 facing the outer rotor 300. The bridge surface may be configured not to form a step with the top surface 811.

The magnetic gear 10 according to an embodiment may include the inner rotor 100 configured to rotate. The magnetic gear 10 may include the outer rotor 300 disposed spaced apart from the inner rotor 100 and configured to accommodate the inner rotor 100. The magnetic gear 10 may include the pole piece 200 disposed between the inner rotor 100 and the outer rotor 300 and spaced apart from the inner rotor 100 and the outer rotor 300. The pole piece 200 may include the plurality of pole piece bodies 210 arranged radially. The pole piece 200 may include the plurality of bridges 220 configured to connect adjacent pole piece bodies 210 of the plurality of pole piece bodies 210. Each of the plurality of pole piece bodies 210 may include the through-hole 215. Each of the plurality of pole piece bodies 210 may include the recessed portion 214 formed on one surface facing the inner rotor 100. Each of the plurality of pole piece bodies 210 may include the fillets 216 and 217 formed on another surface facing the adjacent pole piece bodies 210.

According to the concept of the present disclosure, the through-holes and the recessed portion may be formed in the pole piece to reduce torque ripple by improving the harmonics of the void magnetic flux density that do not contribute to the torque of the magnetic gear.

According to the concept of the present disclosure, the fillets may be formed to fill a portion with air permeability with the pole piece material, which allows more magnetic flux to flow, increasing the transmitted torque to the outer rotor, thereby improving the power density.

The effects to be obtained from the present disclosure are not limited to those mentioned above, and other effects not mentioned will be apparent to a person skilled in the art to which the present disclosure belongs from the following description.

Although specific embodiments have been illustrated and described above, the present disclosure is not limited to the embodiments described above, and it will be apparent to those skilled in the art that various changes and modifications can be made without departing from the gist of the technical spirit of the invention described in the claims below.

1. A magnetic gear, comprising:
an inner rotor configured to receive rotational power;
an outer rotor to be disposed coaxially with a rotation axis of the inner rotor and spaced apart from the inner rotor; and
a pole piece to be disposed between the inner rotor and the outer rotor and spaced apart from the inner rotor and the outer rotor;
wherein the pole piece comprises:
a plurality of pole piece bodies arrangeable along a radial direction with to the rotation axis and spaced apart from each other while the pole piece is disposed between the inner rotor and the outer rotor; and
a plurality of bridges, arrangeable to protrude from the plurality of pole piece bodies, respectively, configured to connect adjacent pole piece bodies among the plurality of pole piece bodies; and
wherein the plurality of pole piece bodies respectively comprise:
a through-hole formed on the plurality of pole piece bodies, respectively;
a recessed portion, formed on a bottom surface of the plurality of pole piece bodies, respectively, facing the inner rotor; and
fillets, configured to be connected to the plurality of bridges, formed on side surfaces of the plurality of pole piece bodies, respectively, such that the adjacent pole piece bodies among the plurality of pole piece bodies face each other.

2. The magnetic gear of claim 1, wherein the recessed portion is recessed along a direction from the inner rotor toward the outer rotor.

3. The magnetic gear of claim 1, wherein the plurality of bridges are formed to respectively protrude from the side surfaces.

4. The magnetic gear of claim 1, wherein the plurality of bridges respectively comprise a bridge surface facing the inner rotor, the bridge surface being configured without a step relative to the bottom surface.

5. The magnetic gear of claim 1, wherein a respective through-hole is formed on a pole piece body, among the plurality of pole piece bodies, along a direction parallel to the rotation axis.

6. The magnetic gear of claim 5, wherein the respective through-hole comprises:
a first through-hole formed on one side of the pole piece body; and
a second through-hole formed on an opposite side of the first through-hole with respect to the recessed portion.

7. The magnetic gear of claim 1, wherein the through-hole comprises a slit shape.

8. The magnetic gear of claim 1, wherein the through-hole has a relative permeability of 1.1 or less.

9. The magnetic gear of claim 1, wherein a depth of the recessed portion is greater than a thickness of the plurality of bridges, respectively.

10. The magnetic gear of claim 4, wherein
the bridge surface is a first bridge surface,
the plurality of bridges further comprises a second bridge surface facing the outer rotor, respectively, and
the fillets are formed to extend from a side surface to the second bridge surface.

11. The magnetic gear of claim 3, wherein
a pole piece body, among the plurality of pole piece bodies, further comprises a top surface facing the outer rotor, and
the plurality of bridges are formed to protrude between the bottom surface and the top surface.

12. The magnetic gear of claim 11, wherein the plurality of bridges respectively comprise:
a first bridge surface facing the inner rotor; and
a second bridge surface facing the outer rotor, and
wherein the fillets comprise:
a first fillet formed to extend from a side surface to the first bridge surface; and
a second fillet formed to extend from a side surface to the second bridge surface.

13. The magnetic gear of claim 1, wherein
the plurality of bridges comprise a bridge surface facing the outer rotor,
a pole piece body, among the plurality of pole piece bodies, comprises a top surface facing the outer rotor, and
the bridge surface is arranged without a step relative to the top surface.

14. The magnetic gear of claim 13, wherein the recessed portion is formed closer to the inner rotor than the bridge surface.
